(19) United States
(12) Patent Application Publication
(10) Pub. No.: US 2009/0083344 A1
(43) Pub. Date: Mar. 26, 2009

(54) Computer system, management computer, and file management method for file consolidation

(75) Inventors: Taro Inoue, Yamato (JP); Yuichi Taguchi, Sagamihara (JP); Hiroshi Nasu, Yokohama (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 12/007,852

(22) Filed: Jan. 16, 2008

(30) Foreign Application Priority Data
Sep. 26, 2007 (JP) 2007-249809

(51) Int. Cl. G06F 12/16; G06F 17/30

(52) U.S. Cl. 707/204; 707/E17.01; 707/E17.032; 711/E12.103

(57) ABSTRACT

Provided is a computer system, including: a computer; and a storage system coupled to the computer via a network. The computer includes: an interface coupled to the network, a processor coupled to the interface and a memory coupled to the processor. The storage system includes a plurality of volumes in which files are stored. The processor is configured to: decide duplicating files from among the files stored in the plurality of volumes as files to be consolidated; identify a plurality of volumes in which the files to be consolidated are stored; select at least one volume from among the identified plurality of volumes as a consolidation volume based on loads imposed on the identified plurality of volumes; and delete the files to be consolidated stored in the volumes that are not selected. Accordingly, in data de-duplication, it is possible to avoid extra loads from centralizing in a high-load-bearing volume.

### CLAIM OF PRIORITY

The present application claims priority from Japanese patent application JP 2007-249809filed on Sep. 26, 2007, the content of which is hereby incorporated by reference into this application.

### BACKGROUND

This invention relates to a data de-duplication technique, in particular, a selection of a volume in which a consolidation destination file is to be stored.

The data de-duplication technique (also referred to as “single instance technique”) is a technique in which if a plurality of the same files exist in a plurality of storage resources, the same files that are duplicating are consolidated into a single file, and the duplicating files are deleted to be replaced by reference information. This technique allows reduction in the size of used storage resources.

US 2002/0129216A1discloses a technique of consolidating files stored in a plurality of storage resources into a file stored in one storage resource.

However, the consolidation of files centralizes access to a consolidation destination file, which increases a load imposed on a volume in which the consolidation destination file is stored. This leads to a problem in that if files are consolidated into a file stored in a high-load-bearing volume, the load imposed on the volume further increases.

### SUMMARY

This invention has been made in view of the above-mentioned problem, and therefore, an object of this invention is to avoid extra loads from centralizing in a high-load-bearing volume when data de-duplication is executed.

A representative aspect of this invention is as follows. That is, there is provided a computer system comprising: a computer and a storage system coupled to the computer via a network. The computer comprises an interface coupled to the network, a processor coupled to the interface and a memory coupled to the processor. The storage system comprises a plurality of volumes in which files are stored. The processor is configured to: decide duplicating files that are stored in the plurality of volumes and have the same contents as files to be consolidated; identify a plurality of volumes in which the files to be consolidated are stored; select at least one volume from among the identified plurality of volumes as a consolidation volume based on loads imposed on the identified plurality of volumes; and delete the files to be consolidated stored in the volumes that are not selected.

According to an aspect of this invention, there is provided a method for data de-duplication that can avoid extra loads from centralizing in a high-load-bearing volume by using load information on volumes and load information on files to decide which file stored in which volume the files are to be consolidated into.

### BRIEF DESCRIPTION OF THE DRAWINGS

The present invention can be appreciated by the description which follows in conjunction with the following figures, wherein:

FIG. 1 is a configuration diagram showing a computer system in accordance with a first embodiment of this invention;

FIG. 2 is an explanatory diagram showing a structure of a file management table in accordance with the first embodiment of this invention;

FIG. 3 is an explanatory diagram showing a structure of a parity group information table in accordance with the first embodiment of this invention;

FIG. 4 is an explanatory diagram showing a structure of a volume information table in accordance with the first embodiment of this invention;

FIG. 5A is an explanatory diagrams showing the status of a loads on a parity group in accordance with the first embodiment of this invention;

FIG. 5B is an explanatory diagrams showing the status of a loads on a parity group in accordance with the first embodiment of this invention;

FIG. 6 is a flowchart showing a storage load information collecting processing for a parity group in accordance with the first embodiment of this invention;

FIG. 7 is a flowchart showing a storage load information collecting processing for a volume in accordance with the first embodiment of this invention;

FIG. 8 is a flowchart showing a processing of data de-duplication in accordance with the first embodiment of this invention;

FIG. 9 is a flowchart showing a consolidation deciding processing in accordance with the first embodiment of this invention;

FIG. 10 is a flowchart showing a detailed processing performed when the file server is instructed to consolidate the files in accordance with the first embodiment of this invention;

FIG. 11 is a flowchart showing a data de-duplication status reporting processing in accordance with the first embodiment of this invention;

FIG. 12 is an explanatory diagrams showing a screen for reporting to the administrator in accordance with the first embodiment of this invention;

FIG. 13 is a configuration diagram showing a computer system in accordance with a second embodiment of this invention;

FIG. 14 is an explanatory diagrams showing a structure of the file information table 8500 in accordance with the second embodiment of this invention;

FIG. 15 is a flowchart showing a file load information collecting processing in accordance with the second embodiment of this invention;

FIG. 16 is a flowchart showing a processing of data de-duplication in accordance with the second embodiment of this invention;

FIG. 17 is a flowchart showing a consolidation deciding processing in accordance with the second embodiment of this invention; and

FIG. 18 is a flowchart showing a detailed processing performed when the file server is instructed to consolidate the files in accordance with the second embodiment of this invention.

### DETAILED DESCRIPTION OF THE PREFERRED EMBODIMENTS

An object to avoid extra loads from centralizing in a high-load-bearing volume in data de-duplication has been achieved by as small number of steps as possible.

Hereinafter, description will be made of embodiments of this invention with reference to the figures.

### First Embodiment

In a first embodiment, a management computer collects load information on volumes in advance, and when a file server executes data de-duplication, the load information on volumes collected by the management computer is used to decide which single file stored in which volume the files are to be consolidated into.

First, description will be made of a computer system according to a first embodiment of this invention.

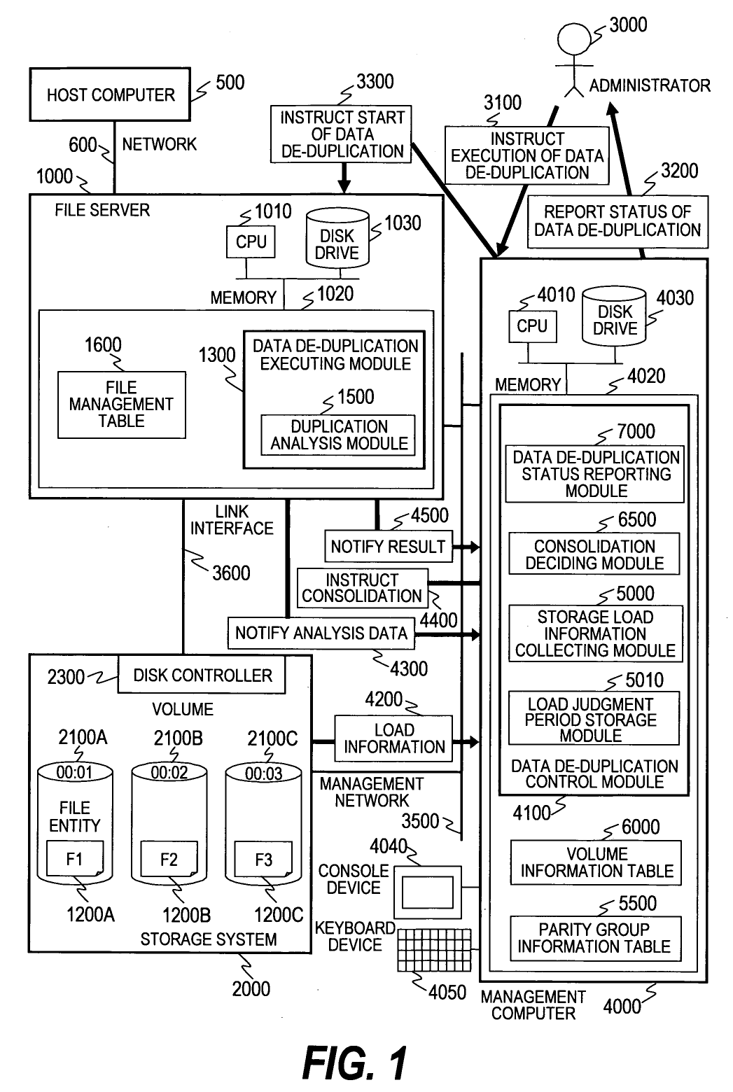

FIG. 1 is a configuration diagram showing the computer system according to the first embodiment of this invention.

The computer system includes a host computer 500, a file server 1000, a storage system 2000, and a management computer 4000. The file server 1000, the storage system 2000, and the management computer 4000 are coupled with one another via a management network 3500. The file server 1000 and the storage system 2000 are coupled to each other via a link interface 3600 (for example, small computer system interface (SCSI)). The host computer 500 and the file server 1000 are coupled to each other via a network 600.

The file server 1000 includes a CPU 1010, a memory 1020, and a disk drive 1030.

The CPU 1010 represents a processor for executing a program stored in the memory 1020 and controlling the entire file server 1000.

The memory 1020 stores a file management table 1600 and a data de-duplication executing module 1300. The memory 1020 may be constituted by a semiconductor memory such as a RAM. At least a part of programs and the like stored in the disk drive 1030 may be copied to the memory 1020 as necessary.

The file management table 1600 is used for managing a correspondence relationship between a file and a file entity 1200. The file entity 1200 represents data stored in a volume 2100 (for example, user data).

The data de-duplication executing module 1300 includes a duplication analysis module 1500. The data de-duplication executing module 1300 is implemented by a program executed by the CPU 1010. The duplication analysis module 1500 is implemented by a subprogram executed by the CPU 1010.

The duplication analysis module 1500 judges which files among those stored in volumes 2100 (2100A, 2100B, and 2100C) are the same.

The disk drive 1030 stores at least one of the programs, user data, and the like. The disk drive 1030 may be constituted by, for example, a hard disk drive (HDD).

The file server 1000 loads various data items and programs, which are read out from the disk drive 1030, onto the memory 1020 upon bootup, and the loaded programs are executed by the CPU 1010.

Upon reception of an access request for a given file from the host computer 500, the file server 1000 references the file management table 1600 to return to the host computer 500 the file entity 1200 corresponding to the file for which the access request has been received.

An administrator 3000 instructs (3100) the management computer 4000 to execute data de-duplication, and the management computer 4000 reports (3200) a status of the data de-duplication to the administrator 3000. When instructed to execute data de-duplication by the administrator 3000, the management computer 4000 instructs (3300) the file server 1000 to start the data de-duplication.

The management computer 4000 includes a CPU 4010, a memory 4020, and a disk drive 4030. The management computer 4000 has a console device 4040 and a keyboard device 4050 coupled thereto.

The CPU 4010 represents a processor for executing a program stored in the memory 4020 and controlling the entire management computer 4000.

The memory 4020 stores a volume information table 6000, a parity group information table 5500, and a data de-duplication control module 4100.

Stored in the volume information table 6000 is operation information on the volumes 2100. Stored in the parity group information table 5500 is operation information on a parity group.

The data de-duplication control module 4100 includes a data de-duplication status reporting module 7000, a consolidation deciding module 6500, a storage load information collecting module 5000, and a load judgment period storage module 5010. The data de-duplication control module 4100 represents a program executed by the CPU 4010. The data de-duplication status reporting module 7000, the consolidation deciding module 6500, the storage load information collecting module 5000, and the load judgment period storage module 5010 each represent a subprogram executed by the CPU 4010.

The data de-duplication status reporting module 7000 reports a processing status of data de-duplication to the administrator 3000. The consolidation deciding module 6500 decides the volumes 2100 whose files are consolidated. The storage load information collecting module 5000 collects load information on the parity group and the volumes 2100 forming the parity group. The load judgment period storage module 5010 prestores a load judgment period as an initial value.

The disk drive 4030 stores at least one of the programs, user data, and the like. The disk drive 4030 may be constituted by, for example, a hard disk drive (HDD).

The console device 4040 represents a device for displaying information to the administrator 3000. The console device 4040 may include at least one of a display device such as a liquid crystal display, a printer, and the like.

The keyboard device 4050 represents a device for receiving an input of information from the administrator 3000.

The management computer 4000 loads various data items and programs, which are read out from the disk drive 4030, onto the memory 4020 upon bootup, and the loaded programs are executed by the CPU 4010.

The management computer 4000 collects load information 4200 from the storage system 2000. The data de-duplication executing module 1300 of the file server 1000 notifies (4300) the management computer 4000 of duplication analysis data. Then, the management computer 4000 instructs (4400) the data de-duplication executing module 1300 of the file server 1000 perform consolidation for data de-duplication, and is notified (4500) of a result by the data de-duplication executing module 1300 of the file server 1000.

The storage system 2000 includes a disk controller 2300 and the volumes 2100 (2100A, 2100B, and 2100C). Hereinafter, the volumes 2100A, 2100B, and 2100C may be referred to collectively as the volume 2100.

The disk controller 2300 reads and writes data with respect to a disk drive (not shown). The disk controller 2300 partitions a storage area of the disk drive into a plurality of volumes 2100 (logical volumes) or joins storage areas of the disk drives, and provides the host computer 500 with the storage area or storage areas that can be recognized as one logical disk drive. A physical storage area having an optional capacity included in the disk drive is allocated to each volume 2100.

The disk drive saves the user data. The disk drive may be, for example, a hard disk drive (HDD), or may be a semiconductor memory device such as a flash memory. The user data represents data written by a computer (for example, the host computer 500). Examples of the user data include document data and the like created by an application (not shown) operating on the host computer 500.

Stored in the volumes 2100 are the file entities 1200 (1200A, 1200B, and 1200C). Hereinafter, the file entities 1200A, 1200B, and 1200C may be referred to collectively as the file entity 1200.

The plurality of volumes 2100 obtained by partitioning or joining forms a parity group. Further, the parity group is partitioned or joined to another parity group to form a redundant arrays of inexpensive disks (RAID) structure.

It should be noted that FIG. 1 illustrates the three volumes 2100, but the storage system 2000 may be provided with any number of volumes 2100.

In the first embodiment of this invention, an input/output count of files within a parity group forming a RAID structure is used as the volume load. It should be noted that a busy rate for access to files may be used as the volume load. Alternatively, the number of times that files stored in the volume 2100 are read out or the number of times that data is written to files may be used as the volume load.

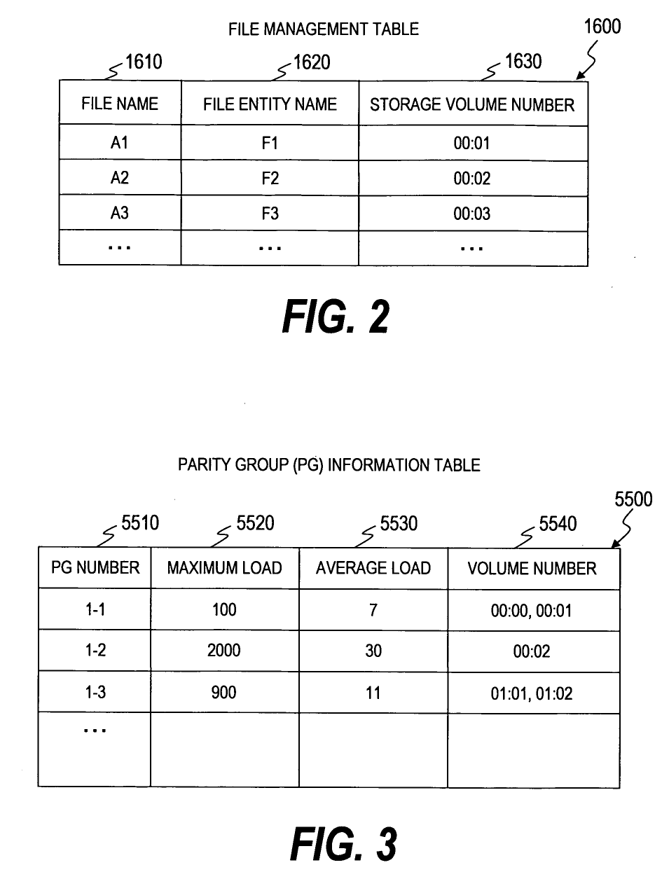

FIG. 2 shows a structure of the file management table 1600 according to the first embodiment of this invention.

The file management table 1600 contains a file name 1610, a file entity name 1620, and a storage volume number 1630.

The file name 1610 represents a name of a file by which the file is identified by the host computer 500.

The file entity name 1620 represents a name of a file entity by which the file is identified by the file server 1000. In other words, the file entity name 1620 indicates a referent by which the file is referenced by the file server 1000.

The storage volume number 1630 represents a number for identifying a volume in which the file entity is stored.

In the example of FIG. 2, “A1”, “F1”, and “00:01” are stored in the first row of the file management table 1600 as the file name 1610, the file entity name 1620, and the storage volume number 1630, respectively. This indicates that a file stored in the volume 2100 is identified as “A1” by the host computer 500, the referent of the file stored in the volume 2100 is “F1”, and the volume 2100 in which the file “A1” is stored is identified as “00:01”.

By changing the file entity name 1620 in the file management table 1600, it is possible to change the correspondence relationship between the file and the file entity. For example, if the file entity name 1620 in the first row of the file management table 1600 is changed from “F1” to “F2”, the referent by which the file “A1” is referenced by the file server 1000 is changed into the file “F2”, and the volume 2100 in which the file “A1” is stored is changed into the volume “00:02” in which the file “F2” is stored.

When the host computer 500 is to access a file, first, the host computer 500 accesses the file server 1000 with the designation of the file name 1610. The file server 1000 uses the file management table 1600 to convert the file name 1610 into the file entity name 1620 corresponding thereto, and uses the file entity name 1620 to access the storage system 2000.

FIG. 3 shows a structure of the parity group information table 5500 according to the first embodiment of this invention.

The parity group information table 5500 contains a parity group (PG) number 5510, a maximum load 5520, an average load 5530, and a volume number 5540.

The PG number 5510 represents a number for identifying a parity group formed of a plurality of volumes.

The maximum load 5520 represents a maximum value of a unit-time-basis input/output count (access count) of files within the parity group during the load judgment period. The load judgment period represents a value decided by the load judgment period storage module 5010 of the management computer 4000.

The input/output count of files represents the number of times that files stored in the plurality of volumes 2100 forming the parity group are read out or that data is written to the files.

The average load 5530 represents an average value of the unit-time-basis input/output count of files within the parity group during the load judgment period.

The volume number 5540 represents a number for identifying the volume 2100 forming the parity group.

In the example of FIG. 3, “1-1”, “100”, “7”, and “00:00, 00:01” are stored in the first row of the parity group information table 5500 as the PG number 5510, the maximum load 5520, the average load 5530, and the volume number 5540, respectively. This indicates that the parity group is identified by “1-1”, the maximum value of the unit-time-basis input/output count of files within the parity group “1-1” during the load judgment period is “100”,the average value of the unit-time-basis input/output count of files within the parity group “1-1” during the load judgment period is “7”, and the parity group “1-1” is formed of the volumes 2100 identified as “00:00” and “00:01”.

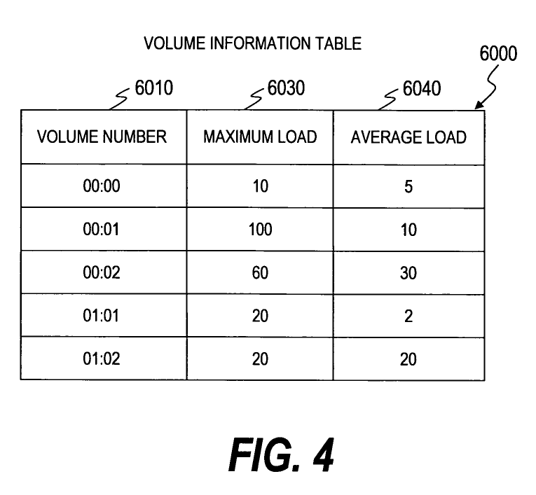

FIG. 4 shows a structure of the volume information table 6000 according to the first embodiment of this invention.

The volume information table 6000 contains a volume number 6010, a maximum load 6030, and an average load 6040.

The volume number 6010 represents a number for identifying a volume in which a file entity is stored.

The maximum load 6030 represents the maximum value of the unit-time-basis input/output count of files within the volume 2100 during the load judgment period. The input/output count of files represents the number of times that files stored in the volumes 2100 are read out or that data is written to the files.

The average load 6040 represents the average value of the unit-time-basis input/output count of files within the volume 2100 during the load judgment period.

In the example of FIG. 4, “00:00”, “10”, and “5” are stored in the first row of the volume information table 6000 as the volume number 6010, the maximum load 6030, and the average load 6040, respectively. This indicates that the volume 2100 is identified by “00:00”, the maximum value of the unit-time-basis input/output count of files within the volume “00:00” during the load judgment period is “10”, and the average value of the unit-time-basis input/output count of files within the volume “00:00” during the load judgment period is “5”.

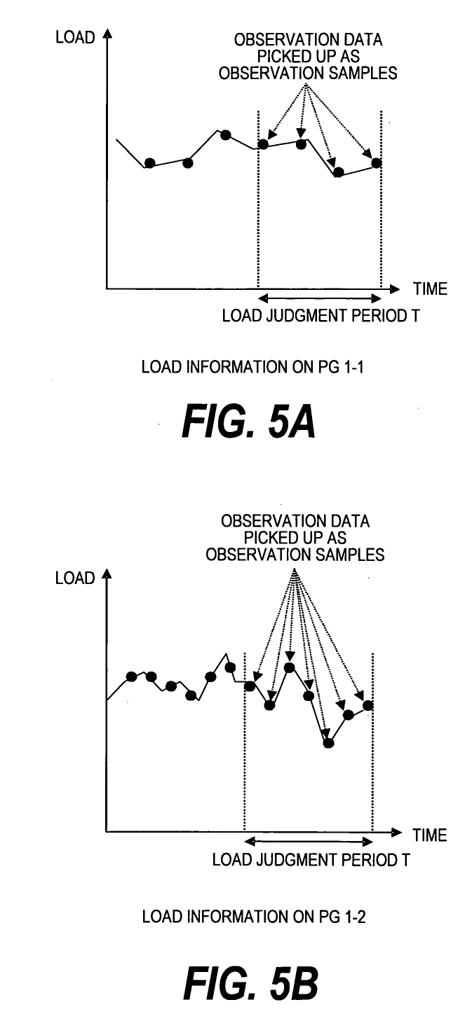

FIG. 5A and FIG. 5B are diagrams each showing a status of loads on the parity group according to the first embodiment of this invention. More specifically, FIG. 5A shows the status of the loads on the parity group “1-1”, and FIG. 5B shows the status of the loads on the parity group “1-2”. The status of the loads represents a change in the input/output count of files stored in the volumes 2100 forming the parity group in a given time period.

It should be noted that both the graphs have an abscissa indicating an elapsed time (Time) and an ordinate indicating a load value (input/output count of files stored in the volumes 2100 forming the parity group). Black circles of the graphs indicate observation data.

The observation data within the load judgment period T defined by the load judgment period storage module 5010 of the management computer 4000 is acquired as observation samples. For example, according to FIG. 5A, the observation samples are four observation data items within the load judgment period T of the parity group “1-1”.

Based on the acquired observation samples, the maximum value and average value of the unit-time-basis input/output count (access count) of files during the load judgment period T are calculated.

As indicated by the graphs of the example of FIG. 5A and FIG. 5B, the parity group “1-1” and the parity group “1-2” have different observation intervals. In this case, the number of observation data items within the load judgment period T are different. For example, the number of observation data items for the parity group “1-1” is “4”,while the number of observation data items for the parity group “1-2” is “7”.

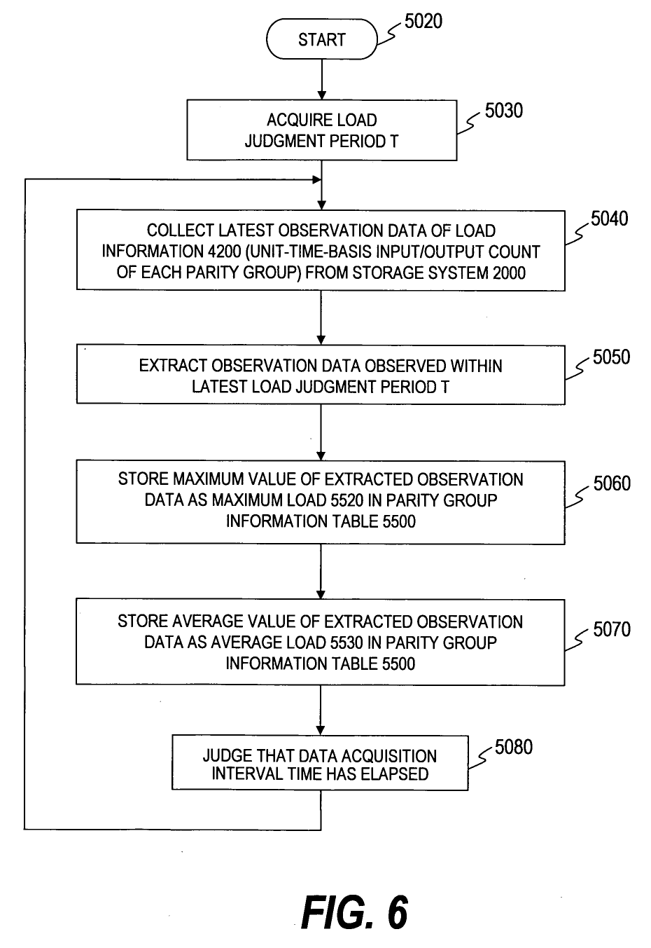

FIG. 6 is a flowchart showing a storage load information collecting processing for the parity group according to the first embodiment of this invention, which is executed by the storage load information collecting module 5000.

First, the storage load information collecting module 5000 acquires the load judgment period T stored in the load judgment period storage module 5010 (Step 5030).

Subsequently, the storage load information collecting module 5000 collects latest observation data of the load information 4200 from the storage system 2000 (Step 5040). To be specific, the storage system 2000 observes the input/output count (access count) of files stored in the volumes 2100 forming the parity group included in the storage system 2000. Then, the storage load information collecting module 5000 collects data of the input/output count of the files observed in the storage system 2000 as the load information 4200.

After that, the storage load information collecting module 5000 extracts observation data acquired within the latest load judgment period T from the load information collected in Step 5040 (Step 5050).

Then, the storage load information collecting module 5000 stores the maximum value of the observation data extracted in Step 5050 (in other words, maximum value of the observation data acquired within the latest load judgment period T) as the maximum load 5520 in the parity group information table 5500 (Step 5060).

Then, the storage load information collecting module 5000 stores the average value of the observation data extracted in Step 5050 (in other words, average value of the observation data acquired within the latest load judgment period T) as the average load 5530 in the parity group information table 5500 (Step 5070).

After the storage load information collecting module 5000 judges that a data acquisition interval time has elapsed, the processing returns to Step 5040 (Step 5080). The data acquisition interval time represents an interval for updating values of the maximum load 5520 and average load 5530 that are stored in the parity group information table 5500.

After the data acquisition interval time has elapsed, the processing returns to Step 5040 to update information of the parity group information table 5500, and the storage load information collecting module 5000 again collects the latest load information 4200 from the storage system 2000.

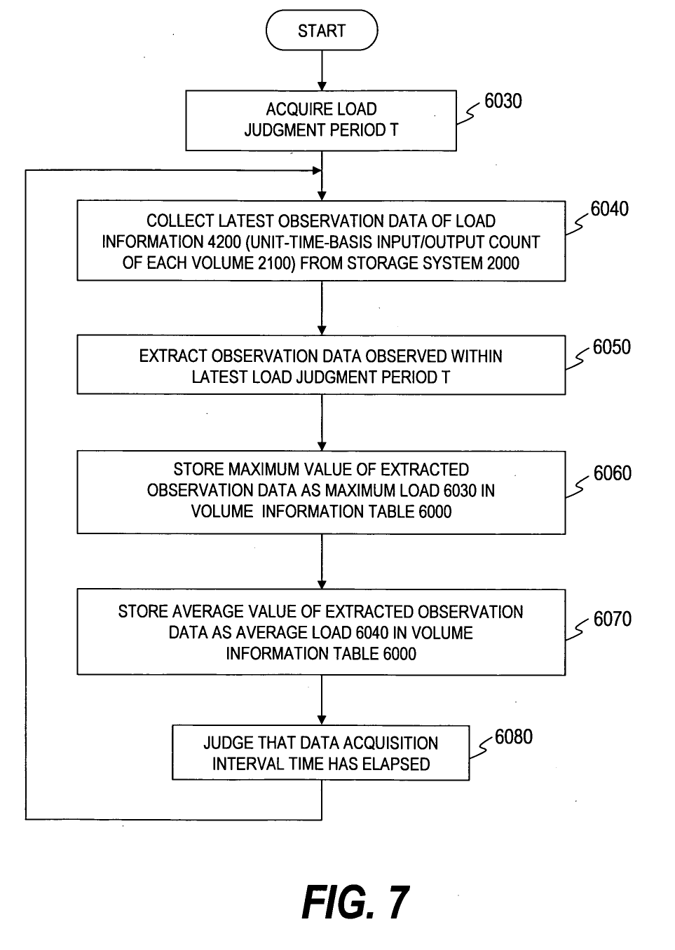

FIG. 7 is a flowchart showing a storage load information collecting processing for the volume according to the first embodiment of this invention, which is executed by the storage load information collecting module 5000.

First, the storage load information collecting module 5000 acquires the load judgment period T stored in the load judgment period storage module 5010 (Step 6030).

Subsequently, the storage load information collecting module 5000 collects latest observation data of the load information 4200 from the storage system 2000 (Step 6040). To be specific, the storage system 2000 observes the input/output count (access count) of files stored in the volumes 2100 forming the parity group included in the storage system 2000. Then, the storage load information collecting module 5000 collects data of the input/output count of the files observed in the storage system 2000 as the load information 4200.

After that, the storage load information collecting module 5000 extracts observation data acquired within the latest load judgment period T from the load information collected in Step 5040 (Step 6050).

Then, the storage load information collecting module 5000 stores the maximum value of the observation data extracted in Step 6050 (in other words, maximum value of the observation data acquired within the latest load judgment period T) as the maximum load 6030 in the volume information table 6000 (Step 6060).

Then, the storage load information collecting module 5000 stores the average value of the observation data extracted in Step 5050 (in other words, average value of the observation data acquired within the latest load judgment period T) as the average load 6040 in the volume information table 6000 (Step 6070).

After the storage load information collecting module 5000 judges that a data acquisition interval time has elapsed, the processing returns to Step 6040 (Step 6080). The data acquisition interval time represents an interval for updating values of the maximum load 6030 and average load 6040 that are stored in the volume information table 6000.

After the data acquisition interval time has elapsed, the processing returns to Step 6040 to update information of the volume information table 6000, and the storage load information collecting module 5000 again collects the latest load information 4200 from the storage system 2000.

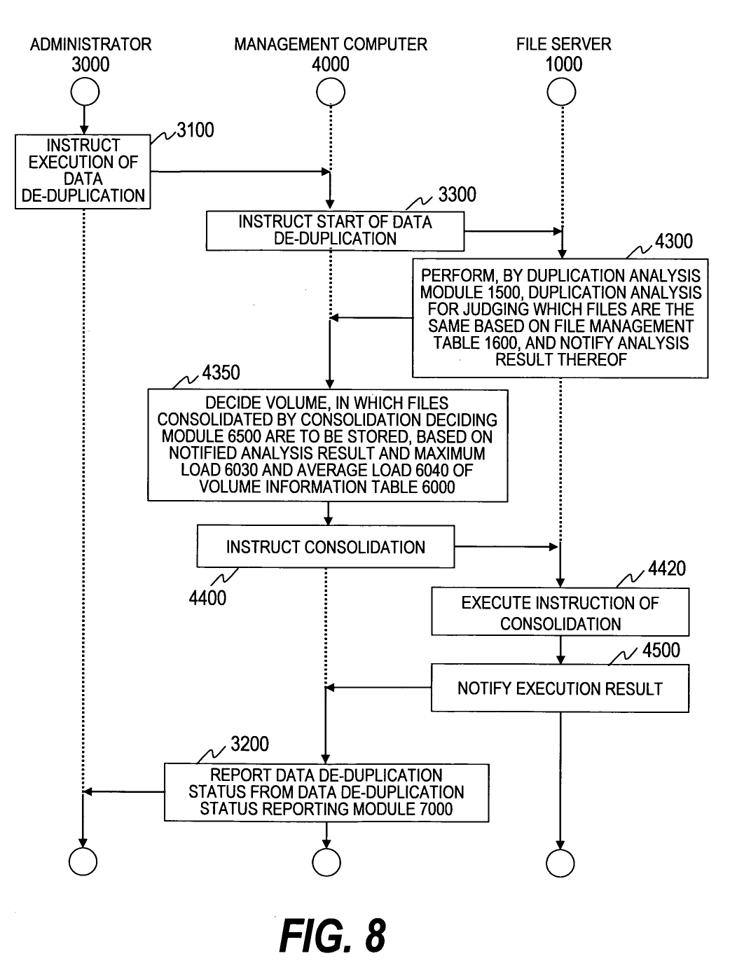

FIG. 8 is a flowchart showing a flow in which data de-duplication is executed according to the first embodiment of this invention.

First, the administrator 3000 instructs the management computer 4000 to execute data de-duplication (Step 3100).

Based on the instruction from the administrator 3000, the management computer 4000 instructs the file server 1000 to start the data de-duplication (Step 3300).

Then, the duplication analysis module 1500 of the file server 1000 performs a duplication analysis, and notifies the management computer 4000 of its analysis result (Step 4300). The duplication analysis represents a processing of judging which files among files stored in the volumes 2100 are the same. The analysis result notified by the file server 1000 contains the file names of the files judged as being the same.

To judge whether or not the files are the same, comparison is performed between the file entities 1200 corresponding to the files stored in the volumes 2100. As a result of the comparison, if the files are judged as being the same, this indicates that the files stored in the volumes 2100 are duplicating.

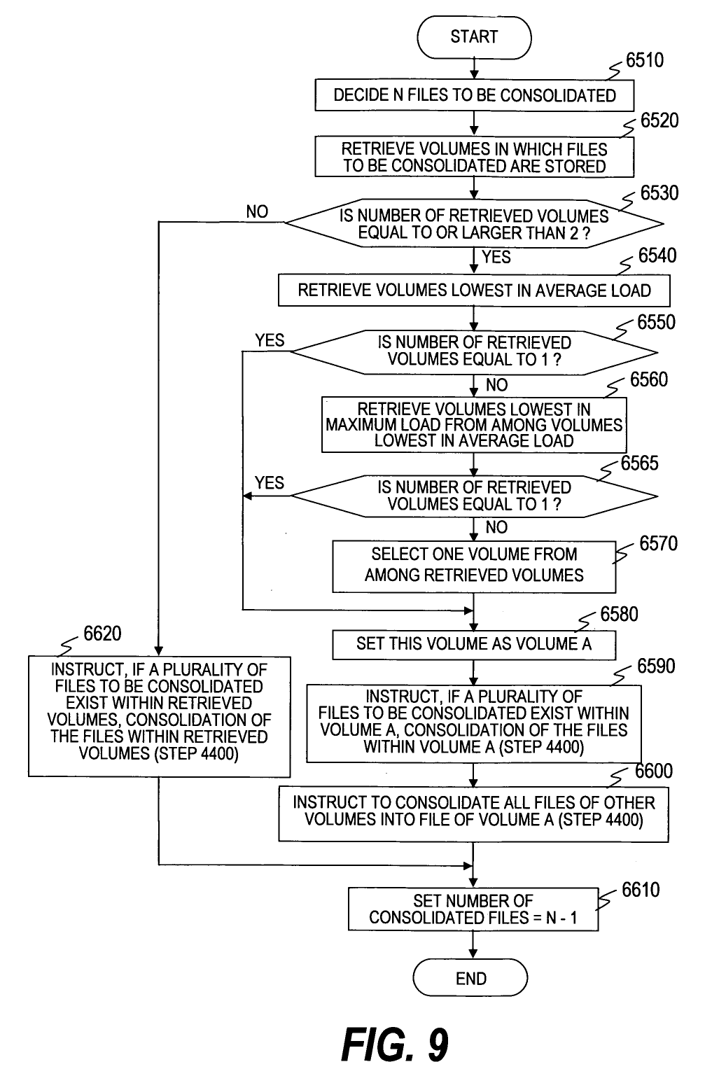

Based on the analysis result notified by the file server 1000 and the information of the maximum load 6030 and average load 6040 of the volume information table 6000, the consolidation deciding module 6500 of the management computer 4000 decides the volume 2100 in which files to be consolidated are to be stored (Step 4350). It should be noted that the processing of the consolidation deciding module 6500 will be described later with reference to FIG. 9.

Then, the consolidation deciding module 6500 of the management computer 4000 instructs the file server 1000 to execute consolidation of the files judged as being the same in Step 4300 (Step 4400). The consolidation represents an operation of changing a plurality of the same files into a single file by executing data de-duplication on the plurality of the same files. To be specific, among the plurality of the same files, only the file stored in the volume 2100 decided in Step 4350 is left, and the same files stored in the other volumes 2100 are deleted.

In response to the instruction from the management computer 4000, the file server 1000 executes the consolidation (Step 4420).

After that, the file server 1000 notifies the management computer 4000 of an execution result of the executed consolidation (Step 4500). The execution result contains the size of the consolidated files, the number of files reduced by executing the consolidation, and the like.

The data de-duplication status reporting module 7000 of the management computer 4000 reports a data de-duplication status to the administrator 3000 (Step 3200). For the reporting to the administrator 3000, for example, the console device 4040 or the like is used. Then, the processing of data de-duplication ends.

FIG. 9 is a flowchart showing a consolidation deciding processing according to the first embodiment of this invention, which is executed by the consolidation deciding module 6500.

First, the consolidation deciding module 6500 decides N files to be consolidated (Step 6510). The files to be consolidated represents the files judged as being the same by the file server 1000 in Step 4300 of FIG. 8. In a case where there exist N files judged as being the same, the consolidation deciding module 6500 decides the N files as the files to be consolidated.

Subsequently, the consolidation deciding module 6500 retrieves volumes in which the files to be consolidated are stored (Step 6520). The consolidation deciding module 6500 previously acquires the file management table 1600 from the file server 1000, and searches the file management table 1600 with the file names of the files to be consolidated as search keys. By acquiring the storage volume number 1630 corresponding to the file name 1610 of the file management table 1600, the consolidation deciding module 6500 can retrieve the volumes 2100 in which the files to be consolidated are stored.

Then, the consolidation deciding module 6500 judges whether or not the number of the volumes 2100 retrieved in Step 6520 is two or more (Step 6530).

If the number of the volumes 2100 retrieved in Step 6520 is two or more, the files to be consolidated are stored in a plurality of volumes 2100, so the consolidation deciding module 6500 needs to select one of the volumes 2100 that has a file into which the files to be consolidated are to be consolidated. The selecting of one of the volumes 2100 that has a file into which the files to be consolidated are to be consolidated is to avoid extra loads from centralizing in a high-load-bearing volume by selecting one volume low in load from the plurality of volumes 2100. In this case, the processing advances to Step 6540.

On the other hand, if the number of the volumes 2100 retrieved in Step 6520 is one, the files to be consolidated are stored in one volume 2100, so the consolidation deciding module 6500 does not need to select one of the volumes 2100 that has a file into which the files to be consolidated are to be consolidated. In this case, the processing advances to Step 6620.

Then, the consolidation deciding module 6500 retrieves volumes lowest in average load (Step 6540). The consolidation deciding module 6500 searches the volume information table 6000 with the volume numbers of the volumes 2100 retrieved in Step 6520 as search keys, and acquires the average loads 6040 of all the retrieved volumes 2100.

The consolidation deciding module 6500 compares the average loads of all the volumes 2100 retrieved in 6520, and selects the volumes 2100 lowest in average load.

Then, the consolidation deciding module 6500 judges whether or not the number of the volumes 2100 retrieved in Step 6540 is one (Step 6550).

If the retrieved number of the volumes 2100 is two or more, the consolidation deciding module 6500 needs to select one of the volumes 2100 that has a file into which the files to be consolidated are to be consolidated. This is because the consolidation deciding module 6500 has not been able to select one of the volumes 2100 that has a file into which the files to be consolidated when the volumes 2100 lowest in average load are retrieved in Step 6540. Therefore, the processing advances to Step 6560.

On the other hand, if the number of the retrieved volumes 2100 is one, the consolidation deciding module 6500 has only to consolidate the files to be consolidated into the file of the one volume 2100, and the processing advances to Step 6580.

Among the volumes 2100 lowest in average load, the consolidation deciding module 6500 retrieves volumes lowest in maximum load (Step 6560). The consolidation deciding module 6500 searches the volume information table 6000 with the numbers of the volumes 2100 retrieved in Step 6540 as search keys, to thereby acquire the maximum loads 6030 corresponding to the volume numbers 6010 for all of the volumes 2100 lowest in average load retrieved in Step 6540.

The consolidation deciding module 6500 compares values of the retrieved maximum loads 6030 for all of the volumes 2100 lowest in average load retrieved in Step 6540, and selects the volumes 2100 having the lowest value of the maximum load.

Then, the consolidation deciding module 6500 judges whether or not the number of the volumes 2100 retrieved in Step 6560 is one (Step 6565).

If the number of the retrieved volumes 2100 is two or more, it is necessary to select one of the volumes 2100 that has a file into which the files to be consolidated are to be consolidated. This is because the consolidation deciding module 6500 has not been able to select one of the volumes 2100 that has a file into which the files to be consolidated when the volumes 2100 lowest in maximum load are retrieved in Step 6560. Therefore, the processing advances to Step 6570.

On the other hand, if the number of the retrieved volumes 2100 is one, the consolidation deciding module 6500 can select one volume 2100 for consolidation, and does not need to select another volume 2100. Therefore, the processing advances to Step 6580.

From among the volumes 2100 lowest in maximum load 6030 retrieved in Step 6560, the consolidation deciding module 6500 selects an arbitrary volume 2100 (Step 6570). The volume 2100 having a small volume number may be selected. Alternatively, the volume 2100 having a large capacity may be selected.

The consolidation deciding module 6500 sets the selected one volume 2100 as Volume A (Step 6580).

If a plurality of files to be consolidated exist within Volume A, the consolidation deciding module 6500 instructs the file server 1000 to consolidate those files within Volume A (Step 6590).

The file server 1000, which has been instructed from the consolidation deciding module 6500 of the management computer 4000, searches the file management table 1600 with the file names 1610 of the files to be consolidated existing within Volume A as search keys, and acquires the file entity names 1620 corresponding to the file names 1610. Then, the file server 1000 selects one file optionally from among the plurality of existing files to be consolidated, and changes the file entity names 1620 of the files to be consolidated that have not been selected into the file entity name 1620 of the selected file to be consolidated. In other words, the file server 1000 changes the referents of the files to be consolidated that have not been selected into the referent of the selected file to be consolidated. The changing of the referents represents an operation of changing access destinations of the files to be consolidated (target to read the files to be consolidated and target to write the files to be consolidated) from the files to be consolidated that have not been selected into the selected file to be consolidated.

For example, in the file management table 1600 of FIG. 2, the files “A1”, “A2”, and “A3” are the files to be consolidated (the same files), and stored in the same volume 2100. If the consolidation deciding module 6500 selects the file “A2” as the one into which the files are to be consolidated, the file entity name “F1” of the file “A1” is changed into “F2”, and the file entity name “F3” of the file “A3” is changed into “F2”.

It should be noted that Step 6590 corresponds to Step 4400 of FIG. 8.

Subsequently, the consolidation deciding module 6500 instructs the file server 1000 to consolidate all of the files to be consolidated stored in the other volumes 2100 into the file of Volume A (Step 6600).

The file server 1000, which has been instructed from the consolidation deciding module 6500 of the management computer 4000, searches the file management table 1600 with the file names 1610 of all the files to be consolidated stored in the other volumes 2100 as search keys, and acquires the file entity names 1620 and storage volume numbers 1630 corresponding to the file names 1610. The file server 1000 changes the file entity names 1620 and storage volume numbers 1630 of all the files to be consolidated stored in the other volumes 2100 into the file entity name 1620 and storage volume number 1630 of the file to be consolidated existing in Volume A. In other words, the file server 1000 changes the referents of all the files to be consolidated stored in the other volumes 2100 into the referent of the file to be consolidated existing in Volume A.

For example, in the file management table 1600 of FIG. 2, the files “A1”, “A2”, and “A3” are the files to be consolidated (the same files), and stored in the different volumes 2100. If the consolidation deciding module 6500 selects the file “A3” as the one into which the files are to be consolidated, the file entity name “F1” and the storage volume number “00:01” of the file “A1” are changed into “F3” and “00:03”, respectively, and the file entity name “F2” and the storage volume number “00:02” of the file “A2” are changed into “F3” and “00:03”, respectively.

It should be noted that Step 6600 corresponds to Step 4400 of FIG. 8.

In Step 6620, if a plurality of files to be consolidated exist within the volume retrieved in Step 6520, the consolidation deciding module 6500 instructs the file server 1000 to consolidate the files within the retrieved volume (Step 6620).

The file server 1000, which has been instructed from the consolidation deciding module 6500 of the management computer 4000, searches the file management table 1600 with the file names 1610 of the files to be consolidated existing within the volume retrieved in Step 6520 as search keys, and acquires the file entity names 1620 corresponding to the file names 1610. Then, the file server 1000 selects one file optionally from among the plurality of existing files to be consolidated, and changes the file entity names 1620 of the files to be consolidated that have not been selected into the file entity name 1620 of the selected file to be consolidated. In other words, the file server 1000 changes the referents of the files to be consolidated that have not been selected into the referent of the selected file.

For example, in the file management table 1600 of FIG. 2, the files “A1”, “A2”, and “A3” are the files to be consolidated (the same files), and stored in the same volume 2100. If the consolidation deciding module 6500 selects the file “A2” as the one into which the files are to be consolidated, the file entity name “F1” of the file “A1” is changed into “F2”, and the file entity name “F3” of the file “A3” is changed into “F2”.

It should be noted that Step 6620 corresponds to Step 4400 of FIG. 8.

The consolidation deciding module 6500 stores “N−1” as the number of the consolidated files (Step 6610). The N files to be consolidated are decided in Step 6510, and (N−1) files to be consolidated excluding the selected one file are consolidated into the selected one file, so the number of the consolidated files is “N−1”. Then, the processing ends.

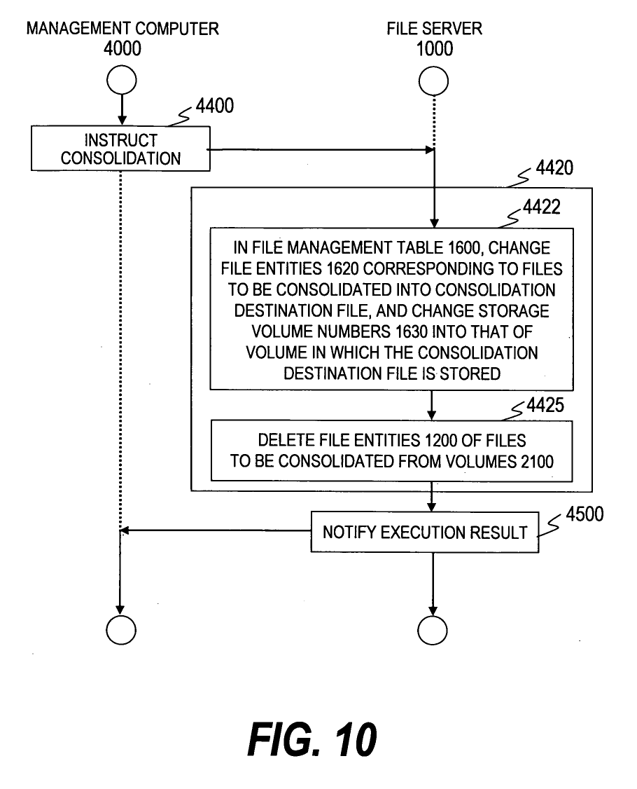

FIG. 10 shows a detailed processing executed when the file server 1000 is instructed to consolidate the files according to the first embodiment of this invention.

The processing performed upon reception of an instruction to consolidate files is executed when the management computer 4000 instructs the file server 1000 to perform consolidation in Step 4400 of FIG. 8.

First, the management computer 4000 instructs the file server 1000 to perform consolidation (Step 4400).

Subsequently, the file server 1000 executes the consolidation instructed by the management computer 4000 (Step 4420). Step 4420 includes Steps 4422 and 4425.

In Step 4422, in the file management table 1600, the file server 1000 changes the file entity names 1620 corresponding to the file names 1610 of the files to be consolidated into the file entity name 1620 of the consolidation destination file, and changes the storage volume numbers 1630 into the storage volume number 1630 of the volume 2100 in which the consolidation destination file is stored (Step 4422).

In Step 4425, the file server 1000 deletes the file entities 1200 of the consolidated files from the volumes 2100 (Step 4425).

The file server 1000 notifies the management computer 4000 of an execution result of the consolidation (Step 4500). Then, the processing ends.

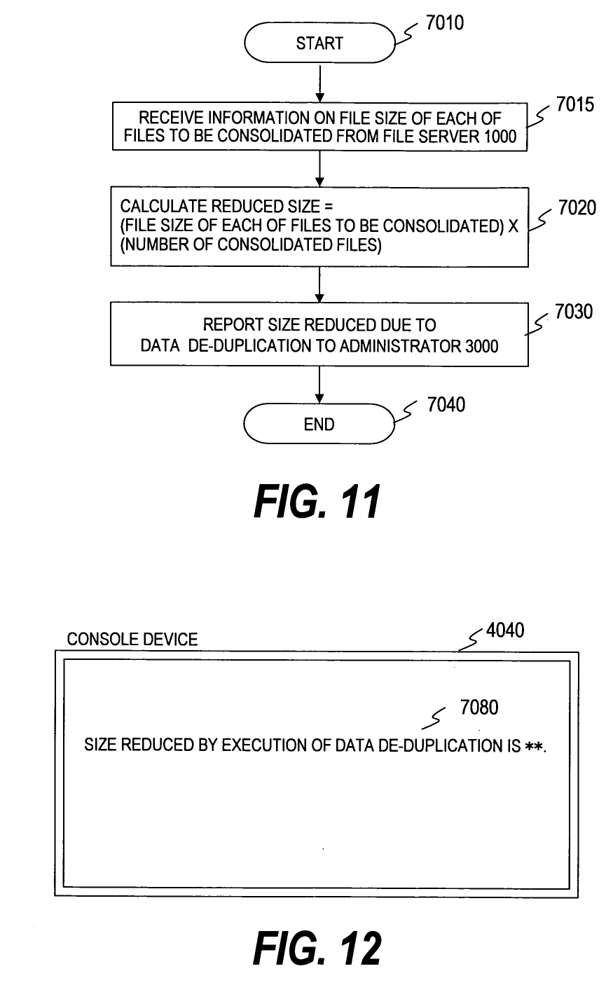

FIG. 11 is a flowchart showing a data de-duplication status reporting processing according to the first embodiment of this invention.

The CPU 4010 of the management computer 4000 executes a program of the data de-duplication status reporting module 7000, to thereby execute the data de-duplication status reporting processing.

First, the data de-duplication status reporting module 7000 receives information on a file size of each of the files to be consolidated from the file server 1000 (Step 7015).

To be specific, the data de-duplication status reporting module 7000 instructs the file server 1000 to transmit information on the file size with the file names of the files to be consolidated as search keys. Upon reception of the instruction, the file server 1000 retrieves the size corresponding to the file name, and transmits the retrieval result to the data de-duplication status reporting module 7000 of the management computer 4000.

Subsequently, the data de-duplication status reporting module 7000 calculates a reduced size from the file size of the files to be consolidated and the number of those files (Step 7020). To be specific, the data de-duplication status reporting module 7000 calculates the reduced size by multiplying the file size of each of the files to be consolidated received in Step 7015 by the number of consolidated files stored in Step 6610 of FIG. 9.

The data de-duplication status reporting module 7000 then reports the size reduced due to the data de-duplication to the administrator 3000 (Step 7030). To be specific, the data de-duplication status reporting module 7000 reports the size calculated in Step 7020 by using, for example, the console device 4040 of the management computer 4000 or the like. Then, the processing ends.

FIG. 12 is an explanatory diagram of a report shown to the administrator 3000 according to the first embodiment of this invention.

The image shown in FIG. 12 is an example of what is reported to the administrator 3000 in Step 7030 of FIG. 11. A report 7080 may be outputted to the console device 4040 of the management computer 4000. In addition, the report 7080 may be outputted on paper by use of a printer (not shown). It should be noted that the report 7080 has a portion “**”, which displays a value of the “reduced size” calculated in Step 7020 of FIG. 11.

In the first embodiment of this invention, such description has been made that the memory 4020 of the management computer 4000 stores the data de-duplication control module 4100. However, the memory 1020 of the file server 1000 may store the data de-duplication control module 4100 to configure the computer system.

### Second Embodiment

In a second embodiment of this invention, the management computer collects load information on volumes and load information on files in advance, and upon execution of the data de-duplication, uses the load information on volumes and the load information on files to decide which M (1<M<N) files stored in which volume 2100 the N files to be consolidated are to be consolidated into.

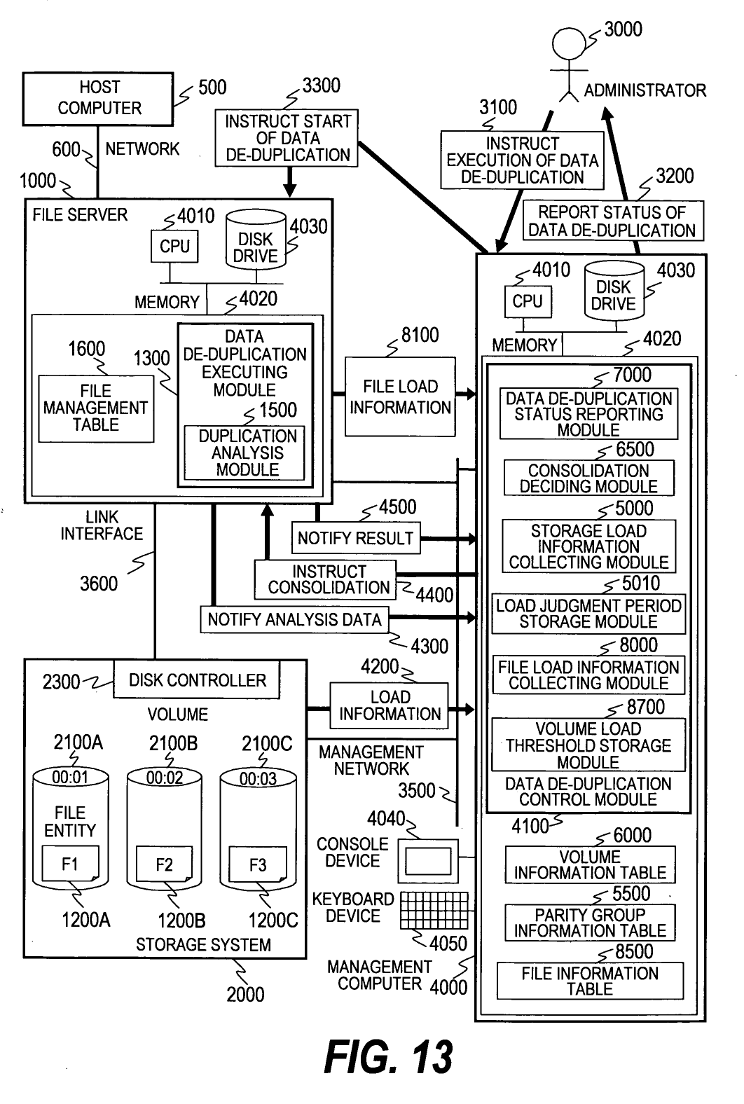

FIG. 13 is a configuration diagram showing a computer system according to the second embodiment of this invention.

The computer system according to the second embodiment differs from the computer system according to the first embodiment in that the memory 4020 of the management computer 4000 stores a file information table 8500, and in that the data de-duplication control module 4100 stored in the memory 4020 includes a file load information collecting module 8000 and a volume load threshold storage module 8700. In addition, the management computer 4000 receives file load information 8100 from the file server 1000.

The file information table 8500 is used for managing information on files stored in the volume 2100.

The file load information collecting module 8000 collects the file load information 8100 from the file server 1000.

As to the volume load threshold storage module 8700, a load threshold is stored in the volume load threshold storage module 8700 in advance as an initial value.

In the second embodiment of this invention, the input/output count of files is used as a file load. The input/output count of files represents the number of times that files are read out or that data is written to the files.

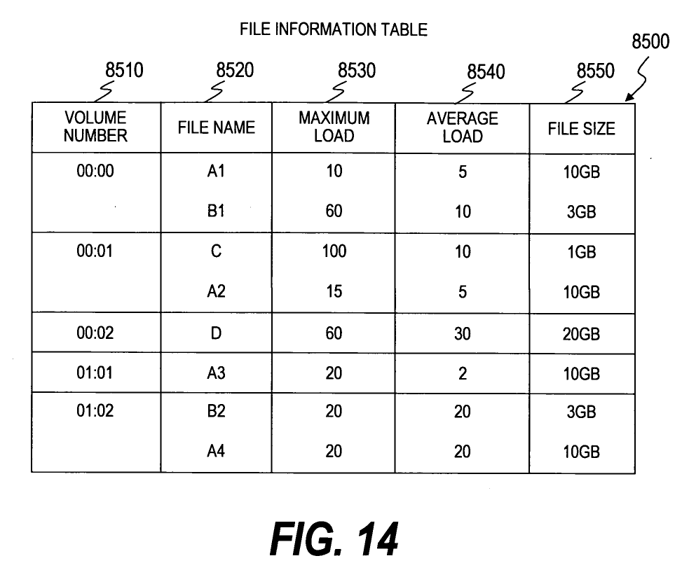

FIG. 14 shows a structure of the file information table 8500 according to the second embodiment of this invention.

The file information table 8500 contains a volume number 8510, a file name 8520, a maximum load 8530, an average load 8540, and a file size 8550.

The volume number 8510 represents a number for identifying each of the volumes 2100 forming the parity group.

The file name 8520 represents a name of a file stored in the volume 2100 identified by the volume number 8510.

The maximum load 8530 represents a maximum value of the unit-time-basis input/output count (access count) of files of the volume 2100 during a load judgment period.

The average load 8540 represents an average value of the unit-time-basis input/output count (access count) of files of the volume 2100 during a load judgment period.

The file size 8550 represents a file size of the file identified by the file name 8520.

In the example of FIG. 14, “00:00”, “A1”, “10”, “5”,and “10GB” are stored in the first row of the file information table 8500 as the volume number 8510, the file name 8520, the maximum load 8530, the average load 8540, and the file size 8550, respectively. This indicates that the volume 2100 is identified by “00:00”, the file name of the file stored in the volume “00:00” is “A1”, the maximum value of the unit-time-basis input/output count of the file “A1” during the load judgment period is “10”, the average value of the unit-time-basis input/output count of the file “A1” during the load judgment period is “5”, and the file size of the file “A1” is “10GB”.

Accordingly, the file information table 8500 makes it possible to know the maximum value and average value of the load on each file during the load judgment period.

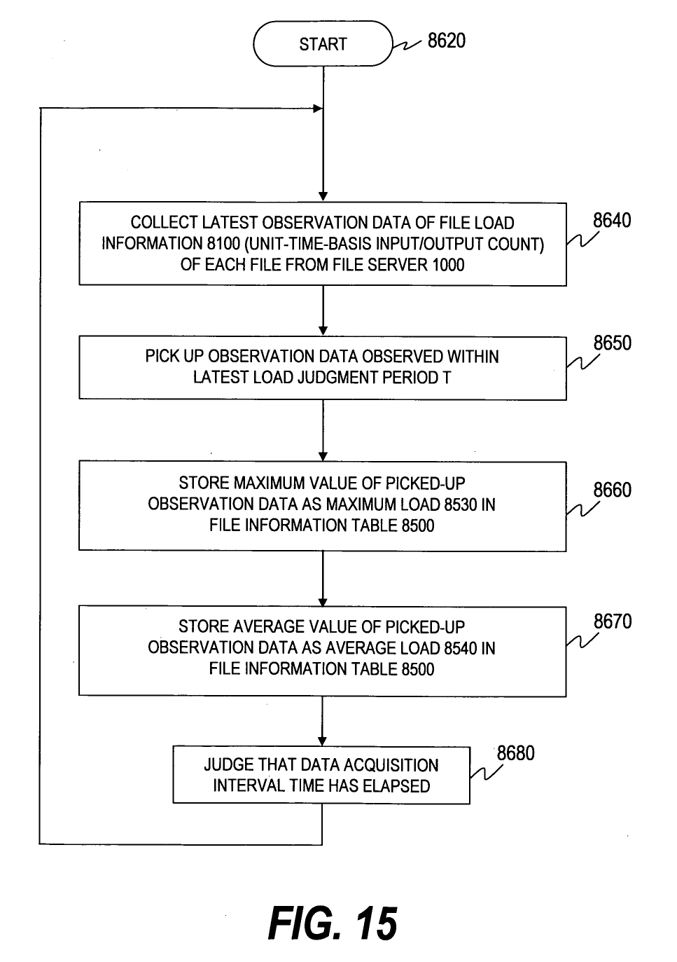

FIG. 15 is a flowchart of a file load information collecting processing according to the second embodiment of this invention, which is executed by the file load information collecting module 8000.

First, the file load information collecting module 8000 collects the latest observation data of the input/output count of the files observed in the file server 1000 as the file load information 8100 (Step 8640).

After that, the file load information collecting module 8000 extracts observation data acquired within the latest load judgment period T from the file load information 8100 collected in Step 8640 (Step 8650).

Then, the file load information collecting module 8000 stores the maximum value of the observation data extracted in Step 8650 (in other words, maximum value of the observation data acquired within the latest load judgment period T) as the maximum load 8530 in the file information table 8500 (Step 8660).

Then, the file load information collecting module 8000 stores the average value of the observation data extracted in Step 8650 (in other words, average value of the observation data acquired within the latest load judgment period T) as the average load 8540 in the file information table 8500 (Step 8670).

After the file load information collecting module 8000 judges that a data acquisition interval time has elapsed, the processing returns to Step 8640 (Step 8680). The data acquisition interval time represents an interval for updating values of the maximum load 8530 and average load 8540 that are stored in the file information table 8500.

After the data acquisition interval time has elapsed, the processing returns to Step 8640 to update information of the respective tables, and the file load information collecting module 8000 again collects the latest file load information 8100 from the file server 1000.

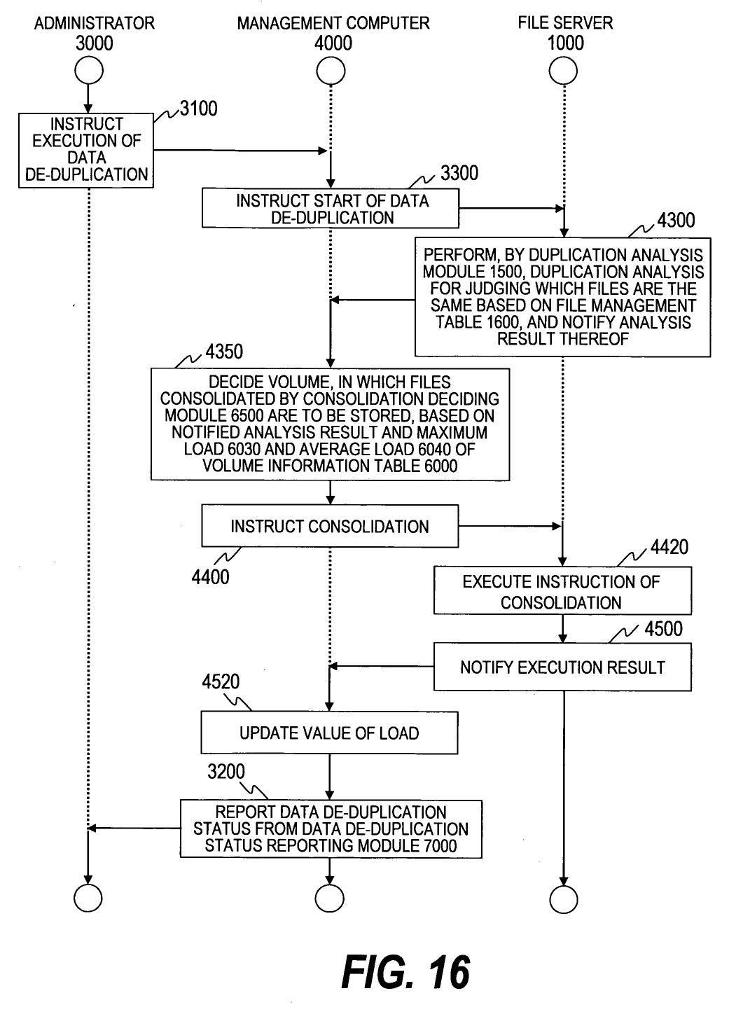

FIG. 16 is a flowchart showing a flow in which data de-duplication is executed according to the second embodiment of this invention.

The flowchart showing a flow in which data de-duplication is executed according to the second embodiment differs from that of the first embodiment in that Step 4520 is added.

In Step 4520, the management computer 4000 updates the value of the load. To be specific, the management computer 4000 updates the maximum load and the average load stored in the respective tables based on the execution result of the consolidation.

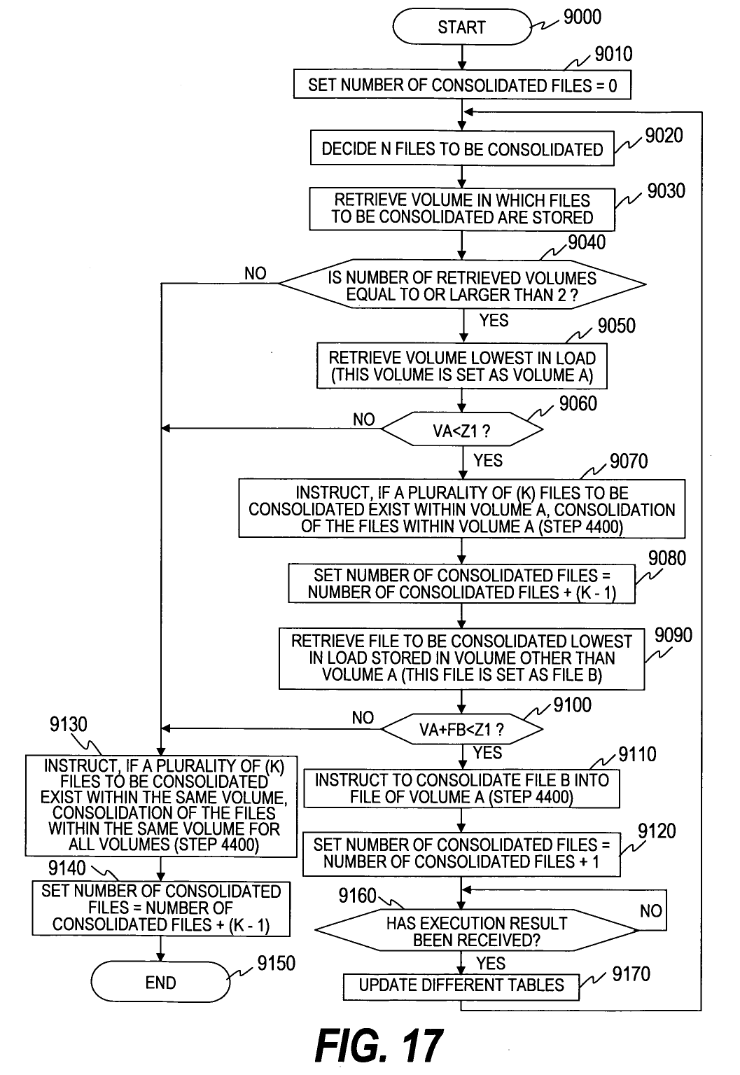

FIG. 17 is a flowchart of a consolidation deciding processing according to the second embodiment of this invention, which is executed by the consolidation deciding module 6500.

In a consolidation deciding processing according to the second embodiment, the volume load of Volume / (/ is a variable) is set as “V/”, the file load of File/is set as “F/”, and the load threshold is set as “Z1”.

First, the consolidation deciding module 6500 sets the number of consolidated files to “0” (Step 9010). The value “0” is set as the initial value of the number of consolidated files.

Subsequently, the consolidation deciding module 6500 decides N files to be consolidated (Step 9020). The consolidation deciding module 6500 decides the files, which have been judged as being the same by the duplication analysis module 1500 of the file server 1000, as the files to be consolidated.

Subsequently, the consolidation deciding module 6500 retrieves volumes in which the files to be consolidated are stored (Step 9030). The consolidation deciding module 6500 previously acquires the file management table 1600 from the file server 1000, and searches the file management table 1600 with the file names of the files to be consolidated as search keys. By acquiring the storage volume number 1630 corresponding to the file name 1610 of the file management table 1600, the consolidation deciding module 6500 can retrieve the volumes 2100 in which the files to be consolidated are stored.

Then, the consolidation deciding module 6500 judges whether or not the number of the volumes 2100 retrieved in Step 9030 is two or more (Step 9040).

If the number of the volumes 2100 retrieved in Step 9030 is two or more, the files to be consolidated are stored in a plurality of volumes 2100, so the consolidation deciding module 6500 needs to select one of the volumes 2100 that has a file into which the files to be consolidated are to be consolidated. The reason for the need to select one of the volumes 2100 that has a file into which the files to be consolidated are to be consolidated is to avoid extra loads from centralizing in a high-load-bearing volume by selecting one volume low in load from the plurality of volumes 2100. In this case, the processing advances to Step 9050.

On the other hand, if the number of the volumes 2100 retrieved in Step 9030 is one, the files to be consolidated are stored in one volume 2100, so the consolidation deciding module 6500 does not need to select one of the volumes 2100 that has a file into which the files to be consolidated are to be consolidated. In this case, the processing advances to Step 9130.

Then, the consolidation deciding module 6500 retrieves volumes lowest in average load (Step 9050). To be specific, the consolidation deciding module 6500 searches the volume information table 6000 with the volume numbers of the volumes 2100 retrieved in Step 9030 as search keys, and acquires the average loads 6040 of all the retrieved volumes 2100.

The consolidation deciding module 6500 compares the values of the average loads 6040 on all the volumes 2100 retrieved in Step 9030, and selects the volume 2100 lowest in average load. If there exist a plurality of volumes 2100 lowest in average load, the consolidation deciding module 6500 selects an arbitrary one volume 2100 from among the volumes 2100 lowest in average load. It should be noted that the volume 2100 having a small volume number may be selected. Alternatively, the volume 2100 having a large capacity may be selected. Then, the selected volume 2100 is set as Volume A.

After that, the consolidation deciding module 6500 judges whether or not the volume load “VA” is lower than the load threshold “Z1” (Step 9060). As the volume load, the maximum load 6030 stored in the volume information table 6000 may be used, or the average load 6040 may be used.

If “VA” is lower than “Z1”, the load on Volume A is lower than the threshold, so it is judged that the files stored in the volumes 2100 other than Volume A can be consolidated into a file within Volume A. Therefore, the consolidation deciding module 6500 needs to retrieve the files to be consolidated into the file within Volume A from the volumes 2100 other than Volume A. In this case, the processing advances to Step 9070.

On the other hand, if “VA” is higher than “Z1”, the load on Volume A is higher than the threshold, so it is judged that the files cannot be consolidated from the volumes 2100 other than Volume A. In this case, the processing advances to Step 9130.

If a plurality of files to be consolidated exist within Volume A, the consolidation deciding module 6500 instructs the file server 1000 to consolidate the files to be consolidated within Volume A (Step 9070).

The file server 1000, which has been instructed from the consolidation deciding module 6500 of the management computer 4000, searches the file management table 1600 with the file names 1610 of the files to be consolidated existing within Volume A as search keys, and acquires the file entity names 1620 corresponding to the file names 1610. Then, the file server 1000 selects one file optionally from among the plurality of (K) existing files to be consolidated, and changes the file entity names 1620 of the files to be consolidated that have not been selected into the file entity name 1620 of the selected file to be consolidated. In other words, the file server 1000 changes the referents of the files to be consolidated that have not been selected into the referent of the selected file to be consolidated.

For example, in the file management table of FIG. 2, the files “A1”, “A2”, and “A3” are the files to be consolidated (the same files), and stored in the same volume 2100. If the consolidation deciding module 6500 selects the file “A2” as the one into which the files are to be consolidated, the file entity name “F1” of the file “A1” is changed into “F2”, and the file entity name “F3” of the file “A3” is changed into “F2”.

After that, the consolidation deciding module 6500 newly sets the number of consolidated files to a value obtained by adding the number of files that have been consolidated so far to the number of files “K−1” consolidated in Step 9070 (Step 9080).

The consolidation deciding module 6500 retrieves a file to be consolidated lowest in load stored in a volume 2100 other than Volume A (Step 9090). To be specific, the consolidation deciding module 6500 searches the file information table 8500 with the file names of files to be consolidated lowest in load stored in the volumes 2100 other than Volume A as search keys, and acquires the average loads 8540 corresponding to the file names 8520. The consolidation deciding module 6500 selects the file having the average load 8540 lowest in value in the acquired values of the average loads 8540. Then, the selected file is set as File B.

It should be noted that in Step 9090, the file having the maximum load 8530 lowest in value may be set as File B by acquiring the maximum load 8530 instead of the average load 8540. In addition, an arbitrary one file to be consolidated may be selected and set as File B instead of the file to be consolidated lowest in load.

The consolidation deciding module 6500 judges whether or not the value obtained by adding the volume load “VA” to the file load “FB” is lower than the load threshold “Z1” (Step 9100). In Step 9100, the judgment may be made based on the maximum load 8530 stored in the file information table 8500. Alternatively, the judgment may be made based on the average load 8540 stored in the file information table 8500.

If “VA+FB” is lower than “Z1”, Volume A is judged to be able to consolidate File B because the load on Volume A, which is even added with the load on File B, does not exceed the load threshold “Z1”. In this case, the consolidation deciding module 6500 needs to instruct the file server 1000 to consolidate File B into the file within Volume A, so the processing advances to Step 9110.

On the other hand, if “VA+FB” is higher than “Z1”, Volume A is judged to be unable to consolidate File B because the load on Volume A, which is added with the load on File B, exceeds the load threshold “Z1”. In this case, the processing advances to Step 9130.

The consolidation deciding module 6500 instructs the file server 1000 to consolidate File B into the file within Volume A (Step 9110).

The file server 1000, which has been instructed from the consolidation deciding module 6500 of the management computer 4000, searches the file management table 1600 with the file name 1610 of File B as a search key, and acquires the file entity name 1620 and storage volume number 1630 corresponding to the file name 1610. Then, the file server 1000 changes the file entity name 1620 and storage volume number 1630 of File B into the file entity name 1620 and storage volume number 1630 of the file to be consolidated existing in Volume A. In other words, the file server 1000 changes the referent of File B into the referent of the file to be consolidated existing in Volume A.

For example, in the file management table 1600 of FIG. 2, if the file “A1” is File B and is to be consolidated into the file “A2”, the file entity name “F1” and the storage volume number “00:01” of the file “A1” are changed into “F2” and “00:02”, respectively.

It should be noted that Step 9110 corresponds to Step 4400 of FIG. 8.

In Step 9120, the consolidation deciding module 6500 newly sets the number of files consolidated so far to a value obtained by adding 1to the number of files that have been consolidated so far.

Then, the consolidation deciding module 6500 judges whether or not the execution result of the consolidation has been received from the file server 1000 (Step 9160).

If the execution result has been received, File B is consolidated into the file stored in Volume A on the file server 1000, so the load information stored in the respective tables is updated. In this case, the processing advances to Step 9170.

On the other hand, if the execution result has not been received, File B is not consolidated into the file stored in Volume A on the file server 1000, so the load information stored in the respective tables is not updated. In this case, the consolidation deciding module 6500 needs to wait for the consolidation of File B, and the processing returns to Step 9160.

Then, the consolidation deciding module 6500 updates the respective tables (Step 9170). To be specific, the file server 1000 executes the consolidation to thereby change the load on the parity group, the load on the volume, and the load on the file. Therefore, the values of the changed loads are stored as the values of the maximum load and the average load in the respective tables, so the information on the loads stored in the respective tables is updated. When the information of the respective tables is updated, the processing returns to Step 9020.

In Step 9130, for every volume, if a plurality of files to be consolidated exist within the same volume, the consolidation deciding module 6500 instructs the file server 1000 to consolidate the files within every volume.

The file server 1000, which has been instructed from the consolidation deciding module 6500 of the management computer 4000, searches the file management table 1600 with the file names 1610 of the files to be consolidated of all the volumes as search keys, and acquires the file entity names 1620 corresponding to the file names 1610. Then, the file server 1000 selects one file optionally from among the plurality of (K) existing files to be consolidated, and changes the file entity names 1620 of the files to be consolidated that have not been selected into the file entity name 1620 of the selected file to be consolidated. In other words, the file server 1000 changes the referents of the files to be consolidated that have not been selected into the referent of the selected file.

For example, in the file management table 1600 of FIG. 2, the files “A1”, “A2”, and “A3” are the files to be consolidated (the same files), and stored in the same volume 2100. If the consolidation deciding module 6500 selects the file “A2” as the one into which the files are to be consolidated, the file entity name “F1” of the file “A1” is changed into “F2”, and the file entity name “F3” of the file “A3” is changed into “F2”.

It should be noted that Step 9130 corresponds to Step 4400 of FIG. 8.

In Step 9140, the consolidation deciding module 6500 newly sets the number of consolidated files to a value obtained by adding the number of files that have been consolidated so far to the number of files “K−1” consolidated in Step 9130 (Step 9140). Then, the processing ends.

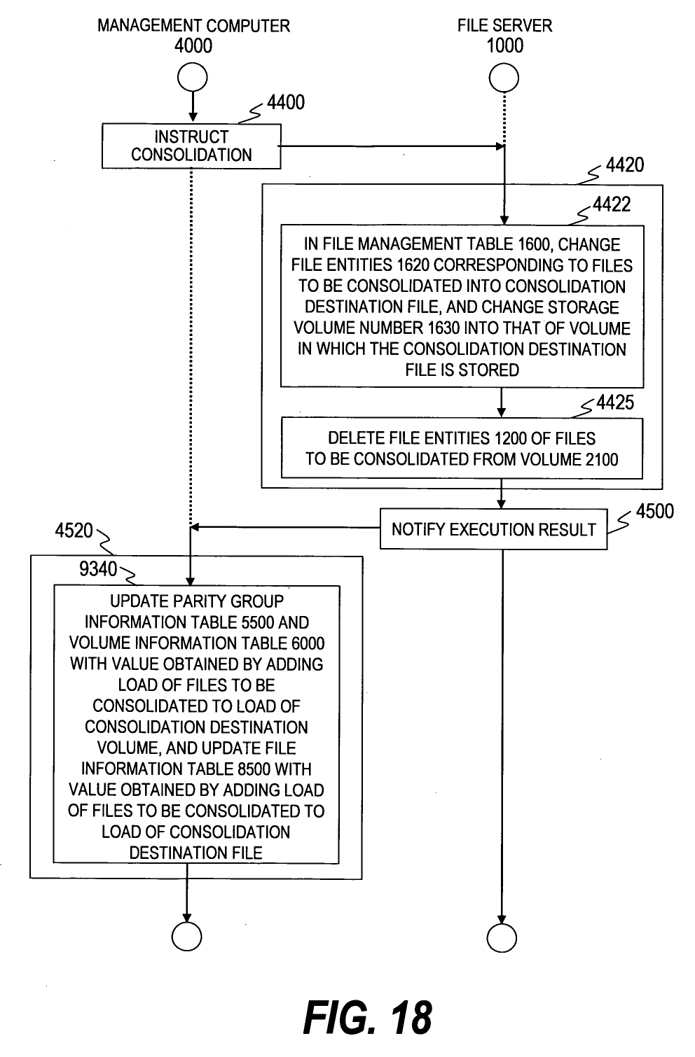

FIG. 18 shows a processing executed when the instruction to consolidate the files according to the second embodiment of this invention.

The processing differs from that of the first embodiment in that Step 4520 of FIG. 16 includes Step 9340.

In Step 9340, the management computer 4000 updates the parity group information table 5500 and the volume information table 6000 with a value obtained by adding the load on files to be consolidated to the load on the consolidation destination volume 2100. In addition, the management computer 4000 updates file information table 8500 with a value obtained by adding the load on the files to be consolidated to the load of consolidation destination file.

To be specific, the management computer 4000 calculates the value obtained by adding the input/output count of the files to be consolidated to the input/output count of the file within the consolidation destination volume 2100. Based on the calculated value, the values of the maximum load and the average load are stored in the parity group information table 5500 and the volume information table 6000.

Further, the management computer 4000 calculates the value obtained by adding the input/output count (access count) of the files to be consolidated to the input/output count (access count) of the consolidation destination file. Based on the calculated value, the values of the maximum load 8530 and the average load 8540 are stored in the file information table 8500.

Accordingly, the management computer 4000 updates the values of the loads in the respective tables when the consolidation is executed.

In the second embodiment of this invention, such description has been made that the memory 4020 of the management computer 4000 stores the data de-duplication control module 4100. However, the memory 1020 of the file server 1000 may store the data de-duplication control module 4100 to configure the computer system.

While the present invention has been described in detail and pictorially in the accompanying drawings, the present invention is not limited to such detail but covers various obvious modifications and equivalent arrangements, which fall within the purview of the appended claims.

What is claimed is:

1. A computer system, comprising:
a computer; and
a storage system coupled to the computer via a network, wherein:
the computer comprises: an interface coupled to the network; a processor coupled to the interface; and a memory coupled to the processor;
the storage system comprises a plurality of volumes in which files are stored; and
the processor is configured to:
decide duplicating files that are stored in the plurality of volumes and have the same contents as files to be consolidated;
identify a plurality of volumes in which the files to be consolidated are stored;
select at least one volume from among the identified plurality of volumes as a consolidation volume based on loads imposed on the identified plurality of volumes; and
delete the files to be consolidated stored in the volumes that are not selected.

2. The computer system according to claim 1, wherein the processor is further configured to select a volume of which load is lowest as the consolidation volume.

3. The computer system according to claim 2, wherein the processor is further configured to switch access to the files to be consolidated stored in the volumes that are not selected into access to a file to be consolidated stored in the consolidation volume.

4. The computer system according to claim 1, wherein the processor is further configured to calculate a deleted size by multiplying the file size of the deleted files to be consolidated by the number of the deleted files to be consolidated.

5. The computer system according to claim 1, wherein the processor is further configured to select at least one volume as the consolidation volume based on the loads of the identified plurality of volumes and information on access to the files to be consolidated stored in the identified plurality of volumes.

6. The computer system according to claim 5, wherein the processor is further configured to:
calculate a load by adding a load information on access to the files to be consolidated stored in the volumes that are not selected to a load of the selected at least one volume; and
decide which files to be consolidated are to be deleted based on the calculated load.

7. The computer system according to claim 6, wherein:
the load of a volume corresponds to an access count of files stored in the volume; and
the loads of files to be consolidated correspond to access count of the files to be consolidated.

8. A management server, comprising:
an interface coupled to a host computer and a storage system via a network;
a processor coupled to the interface; and
a memory coupled to the processor, wherein:
the storage system has a plurality of volumes in which files are stored; and the processor:
decides duplicating files that are stored in the plurality of volumes and have the same contents as files to be consolidated;
identifies a plurality of volumes in which the files to be consolidated are stored;
selects at least one volume from among the identified plurality of volumes as a consolidation volume based on loads imposed on the identified plurality of volumes; and
deletes the files to be consolidated stored in the volumes that are not selected.

9. The management server according to claim 8, wherein the processor selects a volume of which load is lowest as the consolidation volume.

10. The management server according to claim 8, wherein the processor selects the at least one volume as the consolidation volume based on the loads of the identified plurality of volumes and loads of the files to be consolidated stored in the identified plurality of volumes.

11. The management server according to claim 10, wherein the processor:
calculates a load by adding a load information on access to the files to be consolidated stored in the volumes that are not selected to a load of the selected at least one volume; and
decides which files to be consolidated are to be deleted based on the calculated load.

12. The management server according to claim 11, wherein:
the load of a volume corresponds to an access count of files stored in the volume; and
the information on access to the files to be consolidated correspond to access count of the files to be consolidated.

13. The management server according to claim 8, wherein the management server is provided to a file server for managing the files.

14. A file management method executed in a computer system,
the computer system having a computer and a storage system coupled to the computer via a network;
the computer having an interface coupled to the network, a processor coupled to the interface and a memory coupled to the processor;
the storage system having a plurality of volumes in which files are stored; and
the file management method comprising the steps of:
deciding duplicating files that are stored in the plurality of volumes and have the same contents as files to be consolidated;
identifying a plurality of volumes in which the files to be consolidated are stored;
selecting at least one volume from among the identified plurality of volumes as a consolidation volume based on loads imposed on the identified plurality of volumes; and
deleting the files to be consolidated stored in the volumes that are not selected.

15. The file management method according to claim 14, wherein in the step of selecting the at least one volume as a consolidation volume includes selecting a volume of which load is lowest as the consolidation volume.

16. The file management method according to claim 15, further comprising the step of switching access to the files to be consolidated stored in the volumes that are not selected into access to a file to be consolidated stored in the consolidation volume.

17. The file management method according to claim 14, further comprising the step of calculating a deleted size by multiplying the file size of the deleted files to be consolidated by the number of the deleted files to be consolidated.

18. The file management method according to claim 14, wherein the step of selecting the at least one volume as a consolidation volume includes selecting the at least one volume as the consolidation volume based on the loads of the identified plurality of volumes and information on access to the files to be consolidated stored in the identified plurality of volumes.

19. The file management method according to claim 18, wherein:
the step of selecting the at least one volume as a consolidation volume further includes calculating a load by adding a information on access to the files to be consolidated stored in the volumes that are not selected to a load of the selected at least one volume; and
the step of deleting the files includes deciding which files to be consolidated are to be deleted based on the calculated load.

20. The file management method according to claim 19, wherein:
the load of a volume corresponds to an access count of files stored in the volume; and
the load of files to be consolidated correspond to access count of the files to be consolidated.
